(19) United States
(12) Patent Application Publication
(10) Pub. No.: US 2005/0122416 A1
(43) Pub. Date: Jun. 9, 2005

(54) Camcorder having detachable display part

(75) Inventors: Kwan-Hyun Ryu, Seongnam-si (KR); Yong-II An, Goyang-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/998,954

(22) Filed: Nov. 30, 2004

(30) Foreign Application Priority Data
Dec. 8, 2003 (KR) 2003-88700

(51) Int. Cl. H04N 5/222

(52) U.S. Cl. 348/333.07

(57) ABSTRACT

A camcorder having a detachable display part for displaying an image captured by a lens part. The camcorder comprises a camera part that includes a lens part for capturing an image of an object, a record part for recording the captured image selectively, and a display part having a predetermined structure for allowing the display part to be attached to or detached from the camera part. The display part displays the captured image while the display part is attached to, or detached from, the camera part. The display part can further comprise a remote control function for controlling the camera part.

### CROSS-REFERENCE TO RELATED APPLICATIONS

This application claims the benefit of priority under 35 U.S.C. §119(a) to Korean Patent Application No. 2003-88700, entitled CAMCORDER HAVING DETACHABLE DISPLAY PART, filed on Dec. 8, 2003, in the Korean Intellectual Property Office, the entire contents of which are hereby incorporated by reference.

### BACKGROUND OF THE INVENTION

1. Field of the Invention

The present invention relates to a camcorder. More particularly, the present invention relates to a camcorder having a detachable display part capable of photographing an image while viewing the image captured by a lens through the display part even at a remote area from the camera part due to detachability of the display part.

2. Description of the Related Art

A camcorder, which is one type of an image photographing apparatus, is a portable device that photographs moving pictures. Because of this convenience, the camcorder is used worldwide. The conventional camcorder comprises a lens part for capturing an image of an object, a view finder for viewing the image captured by the lens part, a camera part having a record part for selectively recording the captured image in response to a user's selection, and a display part for displaying the image captured by the lens part such that the captured image can be viewed externally.

Generally, the lens part has a zoom function for widening a range of photographable areas. The record part records the image captured by the lens part on a recording medium. A user can then manipulate a corresponding switch and reproduce the recorded image. For the recording medium, a magnetic tape is most widely used. The record part comprises a recording/reproducing device capable of recording the captured image on the recording medium and reproducing the recorded image, and a device for inserting and taking out the recording medium. Camcorders are also available that use a hard disk, a compact disk or a memory stick as a recording medium. Images stored on such recording media can be reproduced and edited via a directly connected computer.

The display part is disposed in one side of the camera part, and since the images captured by the lens part appear in real-time on the viewfinder located outside, the user can conveniently view these captured images without direct physical contact with the view finder. Also, in case of reproducing the recorded image in the record part, the photographed images can be directly viewed since the recorded images are displayed on the outside view finder. One example of a widely used display part is a liquid crystal display (LCD).

In the situation that the camera part has an additional remote control function, photographing can still be performed even though the user is remotely located from where the camcorder is disposed on a tripod or other designated surface. In conventional camcorders, however, the display part is attached to the camera part and the camcorder may have a limited photographable range of areas. For instance, when a user desires to photograph an object located behind an obstacle, the user is unable to accurately photograph the object since it is impossible to confirm the image captured by the lens part through the display part.

Therefore, in order to solve this problem, a camcorder has been developed with a display part capable of rotating towards a lens part for the situation in which a user photographs himself or herself after fixing the camcorder on the tripod. In this situation, however, there may be a problem that the user is unable to accurately confirm the image displayed on the small display part from far away. Also, since the conventional camcorder is designed to photograph an object by holding the camera part with the user's hands, there may be a problem that photographing postures is restricted in certain cases in using the conventional camcorder.

### SUMMARY OF THE INVENTION

It is, therefore, an object of the present invention to provide a camcorder capable of photographing an object even when a display part is attached to the camera part or detached from the camera part thereby increasing the ability to take different photographic postures and increasing the accuracy in taking remote photography. It is another object of the present invention to provide a camcorder with a handle that allows a user to photograph desired objects or scenes freely.

In accordance with one aspect of the present invention, there is provided a camcorder comprising a camera part having a lens part for capturing an image of an object and a record part for recording the captured image selectively, and a display part having a predetermined structure for allowing the display part to be attached to, or detached from, the camera part and for displaying the captured image while the display part is attached to, or detached from, the camera part. The display part further has a remote control function for controlling the camera part.

In accordance with another aspect of the present invention, the camera part comprises a first connection part to which the display part is attached, the first connection part being disposed on a top portion of the camera part, and a first transceiving part for making a wireless signal transmission with the display part. The display part comprises a second connection part connected with the first connection part of the camera part and is disposed on a bottom portion of the display part, and further comprises a second transceiving part for making a wireless signal transmission when the display part is detached from the camera part. The first connection part of the camera part and the second connection part of the display part comprises a wire communication terminal and a charging terminal.

In accordance with an exemplary embodiment of the present invention, the first transceiving part and the second transceiving part are Bluetooth modules. The camera part according to an embodiment of the present invention comprises a handle on a bottom portion and a stabilizer that is formed at a bottom portion of the handle to support the camera part to stand on a floor. Since the camcorder according to an embodiment of the present invention has the detachable display part, it is easier to photograph an object located at the back of an obstacle, and the accuracy in photographing is improved since a user photographs the object while viewing an image of the object displayed on the display part.

Because the handle according to an embodiment of the present invention serves as a stabilizer for supporting the camera part with increased stability, and can furthermore be selectively attached to the camera part, the freedom in taking various photographing postures is increased when an object is photographed by using the camcorder with the detachable display part.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view showing a standing state of a camcorder having a detachable display part according to an embodiment of the present invention;

FIG. 2 is a perspective view showing an opened state of the display part attached to a camera part of the camcorder having the detachable display part shown in FIG. 1;

FIG. 3 is a functional block diagram of a camera part included in a camcorder having a detachable display part according to an embodiment of the present invention;

FIG. 4 is a functional block diagram of a display part included in a camcorder having a detachable display part according to an embodiment of the present invention;

FIG. 5 is a partial cross-sectional view showing a socket of a camera part and plug of a display part in a camcorder having a detachable display part according to an embodiment of the present invention;

FIG. 6 is a bottom view of the display part with the plug shown in FIG. 5;

FIG. 7 is a top view of the camera part with the socket shown in FIG. 5;

FIG. 8 is a perspective view showing a photographing performance with a camcorder having a detachable display part standing on a floor according to an embodiment of the present invention;

FIG. 9 is a perspective view showing a photographing performance by holding a handle of a camcorder having a detachable display part according to an embodiment of the present invention; and

FIG. 10 is a perspective view showing a photographing performance by holding a camera part of a camcorder having a detachable display part according to an embodiment of the present invention.

### DETAILED DESCRIPTION OF THE EXEMPLARY EMBODIMENTS

Certain embodiments of the present invention will be described in greater detail with reference to the accompanying drawings. In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail for purposes of conciseness and clarity.

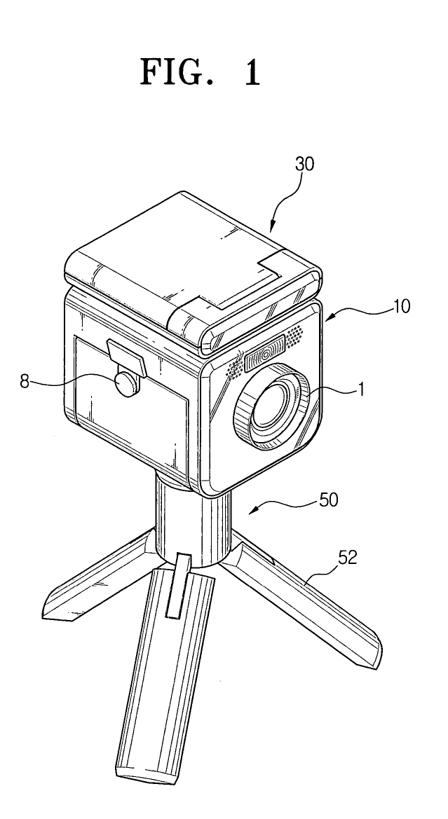

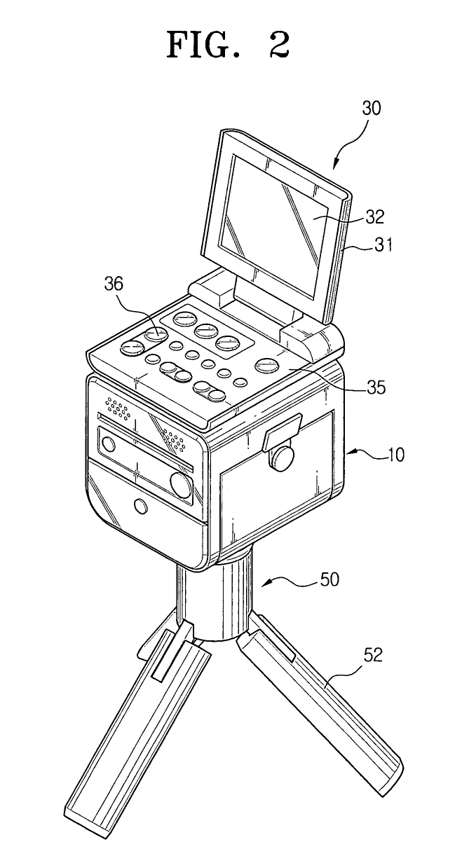

Referring to FIGS. 1 and 2, a camcorder having a detachable display part comprises a camera part 10, a display part 30, and a handle 50. On the exterior side of the camera part 10, there is a holder 8 for hanging a string for providing convenient portability of the camera part 10.

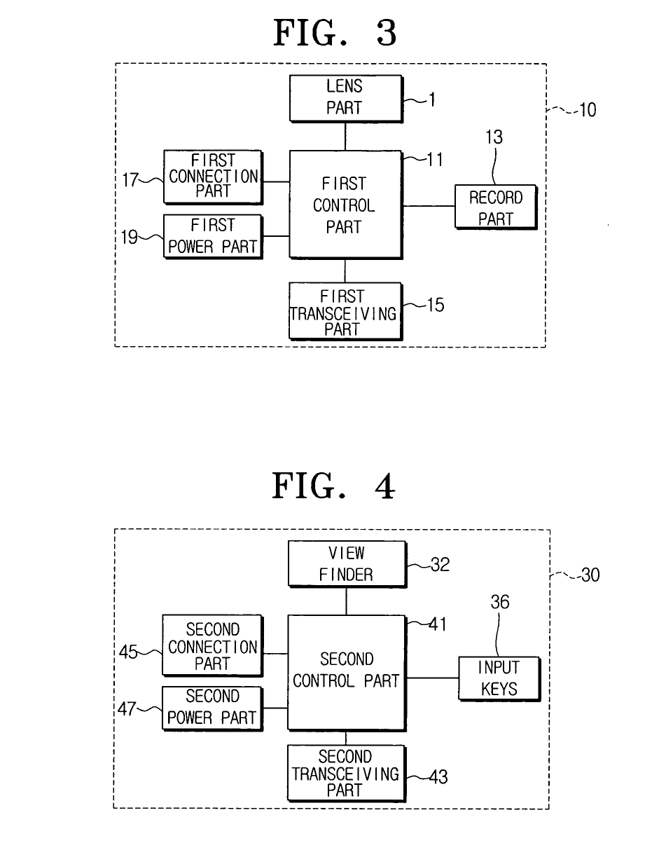

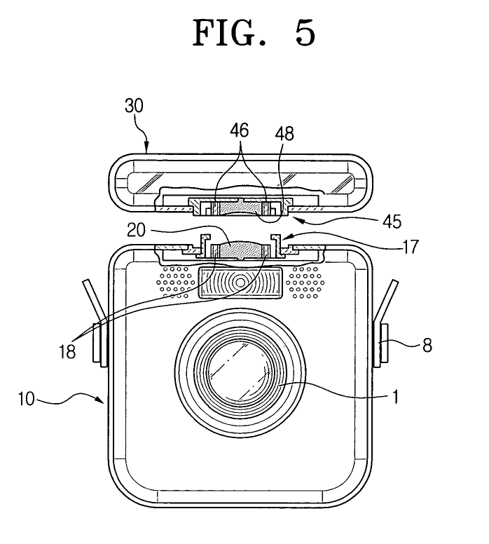

The camera part 10 will be described in more detail with reference to FIG. 3. The camera part 10 comprises a lens part 1 for capturing an image of an object, a record part 13 for selectively recording the captured image by the lens part 1 on a recording medium, and a first control part 11 for converting the above captured image into an electrical signal that can be displayed on display part 30 and for controlling peripheral configuration elements. The camera part 10 further comprises a first transceiving part 15 for wirelessly transmitting the electrical signal converted by the first control part 11 to the display part 30 and for receiving a camera part control signal from the display part 30. The first control part 11 is connected with a first connection part 17 for transmitting the image signal to the display part 30, and is also connected to a first power part 19 for supplying power to the first control part 11 and the peripheral configuration elements.

In an exemplary embodiment of the present invention, the lens part 1 uses a zoom lens capable of varying a focus length. Specifically, the zoom lens automatically operates by a driving source in response to a signal from the control part. Operation of zoom lenses are well known to those skilled in the art of the present invention, and therefore will be omitted. As described above, the record part 13 records an image captured by the lens part 1 on a recording medium. The record part 13 comprises a recording/reproducing device for recording an image signal on a recording medium and for reproducing the recorded image signal, the record part 13 further comprises a recording medium carrying device for inserting the recording medium into a main body of the camera part 10 and for taking the recording medium out of the main body. Although a magnetic tape can be used as the recording medium, a digital recording medium capable of editing/reproducing the recorded data through the use of a computer. In this case, the computer has direct access to the recording medium. Examples of digital recording media are a hard disk, a compact disk and a memory stick. The recording/reproducing device in an exemplary embodiment of the present invention is configured to record data on the above-mentioned digital recording medium and reproduce the recorded data.

The first control part 11 converts an image captured by the lens part 1 into an image signal that can be viewed on the display part 30, and transmits the image signal to the display part 30 through the first connection part 17 or the first transceiving part 15. The first control part 11 controls a photographing activity by controlling the lens part 1 and the record part 13 in response to a signal provided from the display part 30 and received through the first transceiving part 15 or the first connection part 17.

The first transceiving part 15 wirelessly transmits the image signal converted by the first control part 11 to the display part 30. The first transceiving part 15 receives a camera part control signal transmitted wirelessly from the second transceiving part 43 (refer to FIG. 4) of the display part 30, and transmits the camera part control signal to the first control part 11. The first and the second transceiving parts 15 and 43 can use any type of wireless transceiving modules capable of transmitting and receiving image signals, voice signals and other data signals. In an exemplary embodiment of the present invention, however a Bluetooth module is used for a wireless local area network.

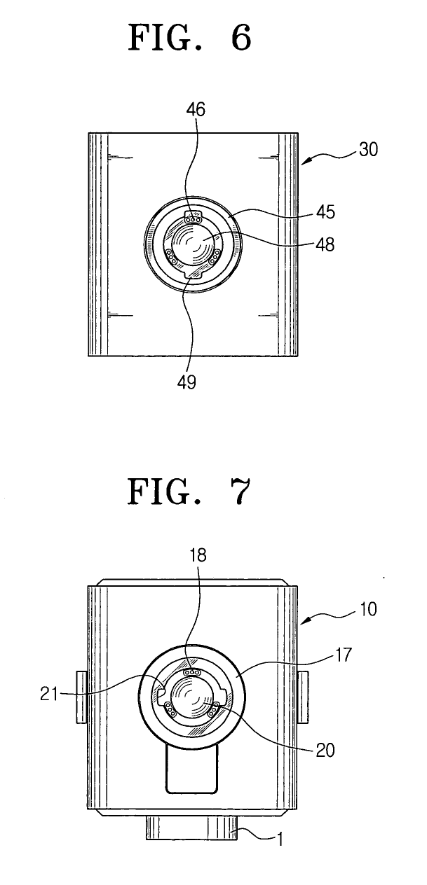

The first connection part 17 fixes the display part 30 to the upper surface of the camera part 10 and transmits various signals between the display part 30 and the camera part 10. As illustrated in FIG. 7, the first connection part 17 is formed as a socket on the upper surface of the camera part 10. A second connection part 45 (FIG. 6) of the display part 30 is assembled with the first connection part 17 to fix the display part 30 onto the camera part 10. Because the first connection part 17 of the camera part 10 is formed in the socket type, the second connection part 45 of the display part 30 therefore is a plug type. It is also possible to have the converse combination, wherein the display part 30 is a socket type and the camera part 10 is formed as a plug type. The first and second connection parts 17 and 45 respectively include first and second wire communication terminals 18 and 46 for transmitting and receiving an image signal and a camera part control signal, and first and second charging terminals 20 and 48 for charging a second power part 47 of the display part 30 by using power supplied from the first power part 19 of the camera part 10. Also, the first and second connection parts 17 and 45 have a first interlocking structure 21 and a second interlocking structure 49 for fixing the display part 30 on the camera part 10, respectively (see FIGS. 6 and 7).

The first power part 19 supplies the power to the first control part 11, the lens part 1, the record part 13, the first transceiving part 15, and the first connection part 17 and, preferably uses a rechargeable battery. The first power part 19 also charges the second power part 47 of the display part 30 through the first and second connection parts 17 and 45.

Referring to FIG. 4, the display part 30 comprises a view finder 32 for displaying an image transmitted from the camera part 10. In an exemplary embodiment of the present invention, there is a remote control function that allows the camera part 10 to be controlled while viewing the displayed image on the view finder 32. The display part 30 comprises the view finder 32 for displaying an image signal transmitted from the camera part 10, input keys 36 for controlling the camera part 10, and the second transceiving part 43 for receiving the image signal wirelessly transmitted from the first transceiving part 15 of the camera part 10 and for wirelessly transmitting signals from the input keys 36. The display part 30 further comprises the second connection part 45 for transmitting and receiving image and camera part control signals via the first connection part 17 of the camera part 10, and a second control part 41 for controlling the view finder 32, the input keys 36, the second transceiving part 43, and the second connection part 45. The display part 30 still further comprises the second power part 47 for supplying power to the view finder 32, the input keys 36, the second transceiving part 43, the second connection part 45, and the control part 41.

FIG. 2 shows an exemplary display part 30 configured as described above according to an embodiment of the present invention. As shown, the display part 30 is formed in a folder type similar to a general notebook. The display part 30 comprises a cover 31, a body 35, and a view finder 32 for displaying an image signal transmitted from the camera part 10 in the cover 31. The display part 30 further comprises, a number of input keys 36 for controlling the camera part 10 that are disposed on a top surface of the body 35. Although not illustrated, a second control part 41, a second transceiving part 43 and a second power part 47 shown and discussed in reference to FIG. 4 are formed inside the body 35. The second connection part 45 is disposed on a bottom surface of the body 35. The view finder 32 is formed in a liquid crystal display (LCD) for displaying an image captured by the lens part 1. The input keys 36 include a variety of keypads typically mounted on a camcorder remote control. For instance, the input keys 36 can include a zoom key for controlling a zoom function of the lens part 1, a record key for recording an image on a recording medium and a reproducing key for reproducing the image recorded on the recording medium.

A transceiving module corresponding to the first transceiving part 15 described in FIG. 3 is built in the second transceiving part 43 in order for the second transceiving part 43 to make wireless communications with the first connection part 15 of the camera part 10 for transmitting and receiving different types of signals, such as image signals, the camera part control signal among others. Therefore, in an exemplary embodiment of the present invention, a Bluetooth module is employed in both the first connection part 15 and the second transceiving part 43. The second control part 41 outputs an image transmitted from the camera part 10 to the view finder 32 by controlling the second transceiving part 43 and the second connection part 45 and transmits the camera part control signal received from the input keys 36 to the camera part 10. The second connection part 45 is formed at a location that corresponds to the first connection part 17 of the camera part 10, and in an exemplary embodiment of the present invention, is formed as a receptacle type that comprises the second wire communication terminal 46 and the second charging terminal 48. As described above, the second power part 47 supplies the necessary power to the view finder 32, the second control part 41, the input keys 36, the second transceiving part 43, and so forth. In an exemplary embodiment of the present invention, the second power part 41 uses a rechargeable battery and is configured such that it is recharged by the first power part 19 of the camera part 10 the power to recharge the second power part 41 by the first power part 19 is transmitted through the first and the second connection parts 17 and 45.

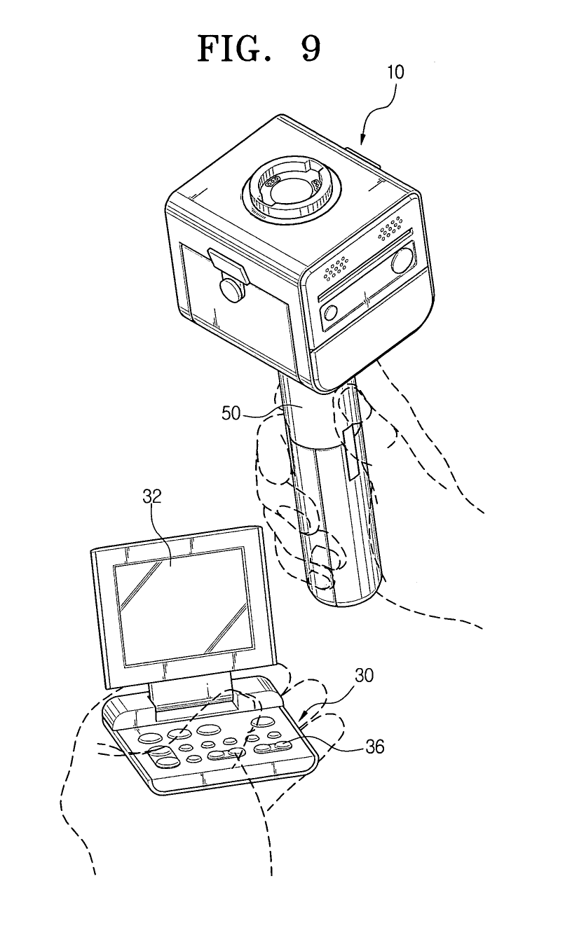

The handle 50 is positioned at the bottom of the camera part 10 and, as shown in FIG. 9, is hand-sized to enable a photographing activity with one hand. A connection opening (not shown) is formed on a top part of the handle 50 such that it mates with an interlocking part (also not shown) disposed on the bottom surface of the camera part 10 to lock the handle 50 and camera part 10 together. Also, as shown in FIG. 1, a stabilizer 52 supports the camera part 10 such that it can stand on the ground. The stabilizer 52 can be attached to the bottom part of the handle 50. In an exemplary embodiment of the present invention, a tripod is used as the stabilizer 52 in order to stably support the camera part 10.

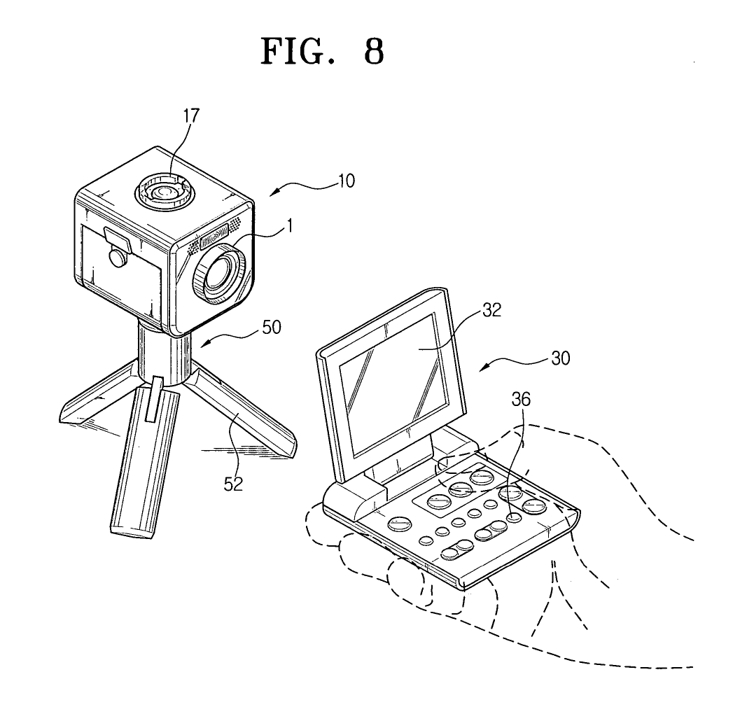

Operation of the camcorder having the detachable display part 30 will now be described in greater detail. As shown in FIG. 8, the display part 30 is detached from the camera part 10. A signal of an image captured by the lens part 1, can be transmitted from the first transceiving part 15 of the camera part 10, and received by the second transceiving part 43 of the display part 30 and displayed on the view finder 32. The user can focus the lens part 1 of the camera part 10 by manipulating the input keys 36 of the display part 30 and record an image on the recording medium.

When the display part 30 is attached to the camera part 10 as depicted in FIG. 2, the second connection part 45 of the display part 30 is inserted into the first connection part 17 of the camera part 10 and the two connection parts tightly interlock together. Wireless signal transmission between the camera part 10 and the display part 30 through the first and the second transceiving parts 15 and 43 is disabled, and the first wire communication terminal 18 of the first connection part 17 and the second wire communication terminal 46 of the second connection part 45 transmit various signals instead. The second power part 47 of the display part 30 is recharged with power from the first power part 19 of the camera part 10 through the first charging terminal 20 of the first connection part 17 and the second charging terminal 48 of the second connection part 45. Hence, a user can record an image on the recording medium while viewing the image displayed on the view finder 32 even when the display part 30 is attached to the camera part 10.

Hereinafter, several exemplary cases of photographing with use of the camcorder having the detachable display part according to an embodiment of the present invention will be described in detail. In the event that a user desires to photograph himself or herself by using the camcorder having the detachable display part, the user stands the camera part 10 on the ground using the stabilizer 52 of the handle 50, and then positions herself in front of the lens part 1 of the camera part 10. This photographing operation is illustrated in FIG. 8. The lens 1 of the camera part 10 can be focused on the user through manipulation of the input keys 36. The user's photograph of himself is substantially identical to the image the user displays on the view finder 32 of the display part 30. Therefore, the image can be verified through the display part 30 even though the image is photographed in a remote area.

If a user intends to photograph an object located behind an obstacle, the user can still photograph the object by grabbing the handle 50 attached to the camera part 10 with one hand and the display part 30 with the other hand. By using the handle 50, the user faces the lens part 1 of the camera part 10 to the rear of the obstacle and then confirms the image displayed on the view finder 32 of the display part 30. The camera part 10 can be moved with the aid of the handle 50 until the desired image of the object is displayed on the view finder 32, and if the desired image is displayed, the desired image is recorded on the recording medium by operating the input keys 36 of the display part 30.

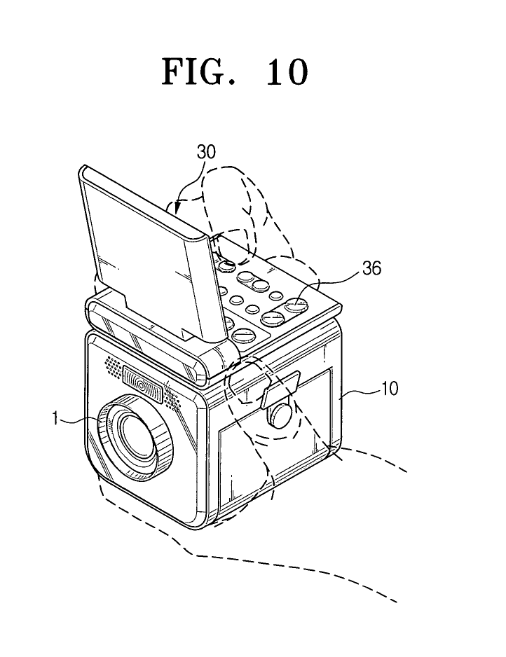

If a user desires to photograph an object using a conventional photographing method, as shown in FIG. 10, the user first attaches the display part 30 to the camera part 10 and then holds the camera part 10 and photographs the object by manipulating the input keys 36 while viewing the displayed image on the view finder 32.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A camcorder, comprising:
a camera part having a lens part for capturing an image of an object and a record part for recording the captured image selectively; and
a display part having a predetermined structure for allowing the display part to be attached to or detached from the camera part and, wherein the display part displays the captured image while the display part is attached to or detached from the camera part.

2. The camcorder of claim 1, wherein the display part further comprises a remote control function for controlling the camera part.

3. The camcorder of claim 1, wherein the camera part comprises a first connection part for connection with the display part and a first transceiving part for making a wireless signal transmission with the display part, and
the display part comprises a second connection part for connecting with the first connection part of the camera part and a second transceiving part for making a wireless signal transmission when the display part is detached from the camera part.

4. The camcorder of claim 3, wherein each of the first connection part of the camera part and the second connection part of the display part comprises a wire communication terminal and a charging terminal.

5. The camcorder of claim 3, wherein the first transceiving part and the second transceiving part are Bluetooth modules.

6. The camcorder of claim 3, wherein the first connection part is disposed on a top portion of the camera part.

7. The camcorder of claim 3, wherein the second connection part is disposed on a bottom portion of the display part.

8. The camcorder of claim 1, wherein the camera part has a handle on a bottom portion.

9. The camcorder of claim 8, wherein a stabilizer is formed at a bottom portion of the handle to support the camera part to stand on a floor.

10. The camcorder of claim 1, wherein the predetermined structure of the display part comprises:
a second interlocking structure.
